(19) United States
(12) Patent Application Publication
(10) Pub. No.: US 2024/0199931 A1
(43) Pub. Date: Jun. 20, 2024

(54) ONE-COMPONENT POLYURETHANE ADHESIVE

(71) Applicants: DDP SPECIALTY ELECTRONIC MATERIALS US, LLC, WILMINGTON, DE (US); ROHM AND HAAS ELECTRONIC MATERIALS (SHANGHAI) LTD., Shanghai (CN)

(72) Inventors: HUIDE D. ZHU, ROCHESTER, MI (US); MATTHEW FELDPAUSCH, AUBURN HILLS, MI (US); WEIGUO SHAO, SHANGHAI (CN); TYLER AUVIL, LAKE ORION, MI (US); LIRONG ZHOU, ROCHESTER HILLS, MI (US); DANIEL SOPHIEA, LAKE ORION, MI (US); ANDREAS LUTZ, GALGENEN (CH)

(21) Appl. No.: 18/555,980

(22) PCT Filed: Jun. 16, 2021
(86) PCT No.: PCT/CN2021/100331

§ 371 Date: Oct. 18, 2023

(51) Int. Cl. C09J 175/08; C08G 18/12; C08G 18/20; C08G 18/24; C08G 18/40; C08G 18/42; C08G 18/48; C08G 18/72; C08G 18/75; C08G 18/76; C08K 3/22; C08K 5/3492; C08K 5/5313; C09J 9/00

(52) U.S. Cl. CPC C09J 175/08; C08G 18/12; C08G 18/2081; C08G 18/244; C08G 18/4018; C08G 18/4238; C08G 18/4812; C08G 18/4825; C08G 18/4829; C08G 18/721; C08G 18/755; C08G 18/7671; C09J 9/00; C08K 2003/2227; C08K 5/34928; C08K 5/5313; C08K 2201/005

(57) ABSTRACT

Provided herein is a one-component polyurethane adhesive composition showing good mechanical characteristics, non-sag performance, product storage stability, as well as flame-retardancy.

### FIELD OF INVENTION

The present invention relates to the field of one-component, moisture-curable polyurethane adhesives.

### BACKGROUND OF THE INVENTION

One part polyurethane adhesives are used extensively in the automotive industry. Commercial adhesives are designed to offer both strong adhesion performance and good physical properties. With the advent of electric vehicles, such adhesives are playing an increasing role in elements of battery assemblies.

Flame-retardancy is of importance in automotive applications, and particularly in battery assemblies, where the adhesive is exposed directly to high voltage and current.

There exists a need for one-component polyurethane adhesives capable of providing good mechanical characteristics and flame-retardancy.

### SUMMARY OF THE INVENTION

In a first aspect, the invention provides a one-component, moisture-curable polyurethane adhesive comprising:
(A) at least one polyurethane prepolymer;
(B) at least one amine catalyst and optionally an organometallic catalyst;
(C) the flame retardants/synergists aluminium hydroxide, melamine polyphosphate and aluminium diethylphosphinate; and
(D) optionally adhesion promoters, fillers.

In a second aspect, the invention provides a method for adhering two substrates, comprising the steps:
(1) providing a one-component, moisture-curable polyurethane adhesive according to the invention;
(2) applying the adhesive to a first substrate, a second substrate, or both;
(3) placing the first and second substrates in adhesive contact, whereby the adhesive is sandwiched between them; and
(4) allowing the adhesive to cure.

In a third aspect, the invention provides an adhered assembly comprising:
(1) a first substrate;
(2) a second substrate;
(3) a one-component, moisture-curable polyurethane adhesive according to the invention;
wherein the first and second substrates are in adhesive contact with the adhesive sandwiched between them.

### Detailed Description of the Invention

### DESCRIPTION OF THE DRAWING

FIG. 1 depicts the method for measuring sag used in the Examples, where 1 is the adhesive bead, 2 is the panel and 3 is the bench.

The inventors have surprisingly found that a composition comprising:
(A) at least one urethane prepolymer resin;
(B) at least one amine catalyst and optionally an organometallic catalyst;
(C) the flame retardants/synergists aluminium hydroxide, melamine polyphosphate and aluminium diethylphosphinate; and
(D) optionally adhesion promoters, fillers;
shows good flame-retardancy (passing UL94 V0 flammability test), good adhesive properties, high electric resistivity, and non-sagging performance.

### Definitions and Abbreviations

ATH aluminium hydroxide, Al(OH)₃
MDI 4,4′-Methylenebis(phenyl isocyanate)
HDI Hexamethylene diisocyanate
IPDI isophorone diisocyanate
MPP melamine polyphosphate
PU polyurethane
SEC size exclusion chromatography
RH relative humidity

Molecular weights of polymers as reported herein are reported in Daltons (Da) as number or weight average molecular weights, as determined by size exclusion chromatography (SEC).

### Polyurethane Prepolymer (A)

The inventive compositions comprise a polyurethane prepolymer.

Polyurethane prepolymers include polymers that are made by polymerizing at least one polyether polyol and/or polyester polyol in the presence of a polyisocyanate, preferable diisocyanate.

Polyether polyols useful in the invention include for example, polyether polyols, poly(alkylene carbonate)polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which are prepared by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains with ethylene oxide chains capping the polyol. In a preferred embodiment, the polyether polyols are a mixture of polyether diols and polyether triols. Preferably, the polyether polyol or mixture has a functionality of at least about 1.5, more preferably at least about 1.8, and is most preferably at least about 2.0; and is preferably no greater than about 4.0, more preferably no greater than about 3.5, and is most preferably no greater than about 3.0. Preferably, the equivalent weight of the polyether polyol mixture is at least about 200, more preferably at least about 500, and is more preferably at least about 1,000; and is preferably no greater than about 5,000, more preferably no greater than about 3,000, and is most preferably no greater than about 2,500.

Polyester polyols include any hydroxyl terminated polyesters. Particularly preferred are hydroxyl terminated aliphatic polyesters.

Polyester prepolymers include polymers that are made by reacting one or more linear copolyesters with primary hydroxyl functionality with a polyisocyanate, preferably a diisocyanate. Particularly preferred are copolyesters having molecular weight of 3,000-4,000 Da, preferably 3,500 Da.

The diisocyanate that may be used to make the polyester prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a preferred embodiment, the polyester prepolymer is made by reacting a copolyester of molecular weight of 3,500 Da with MDI.

In a preferred embodiment, the polyester prepolymer is made by reacting an aliphatic polyester of molecular weight 3,500 with MDI. In a particularly preferred embodiment, the polyester prepolymer is made be reacting 65 to 80 wt % polyester diol with 5 to 15 wt % MDI.

More specific examples of polyether polyols include:
1. Difunctional polyols (diols), such as poly(alkylene oxide)diols, where the alkylene group is C₂ to C₄, particularly poly(ethylene oxide)diol, poly(propylene oxide)diol and poly(tetramethylene oxide)diol, with poly(propylene oxide)diol being particularly preferred. In a particularly preferred embodiment the polyether prepolymer comprises a nominally difunctional, poly(propylene oxide) having a hydroxyl number of 56 (equivalent weight 1000);
2. Trifunctional polyols (triols), such as those based on the akylene oxides initiated with a trifunctional polyol, such as trimethylolpropane, where the alkylene group is C₂ to C₄, particularly ethylene oxide, propylene oxide, tetramethylene oxide and butylene oxide, with propylene oxide being particularly preferred. In a particularly preferred embodiment, the polyether prepolymer comprises a nominally trifunctional poly(propylene oxide) having a hydroxyl number of 36 (equivalent weight 1558); the polymer may or may not be capped with ethylene oxide to modify reactivity.
3. A mixture of 1 and 2. Particularly preferred is a mixture of 1 and 2, more particularly preferred is a mixture of a) a nominally difunctional, poly(propylene oxide) having a hydroxyl number of 56 (equivalent weight 1000) and b) a nominally trifunctional poly(propylene oxide) having a hydroxyl number of 36 (equivalent weight 1558), particularly at a weight ratio b)/a) of 1:2 to 2:1.

The at least one polyurethane prepolymer may comprise a mixture of a polyether polyol-based prepolymer and a polyester-based prepolymer.

In a particularly preferred embodiment, the polyurethane prepolymer is a mixture of a prepolymer based on polyether diol and polyether triol, and a polyester diol-based prepolymer.

The diisocyanate that may be used to make the polyether prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a particularly preferred embodiment, the polyether prepolymer comprises a nominally difunctional poly(propylene oxide) and a nominally trifunctional poly(propylene oxide), reacted with MDI.

In a particularly preferred embodiment, the polyether prepolymer comprises a nominally difunctional poly(propylene oxide) having a hydroxyl number of 56 (equivalent weight 1000) and a nominally trifunctional poly(propylene oxide) having a hydroxyl number of 36 (equivalent weight 1558), reacted with MDI.

The polyether prepolymer is made by reacting the at least one polyether polyol with the polyisocyanate, using a catalyst capable of catalyzing the reaction of an NCO group with a hydroxyl group. Examples of such catalysts include tertiary amine catalysts, alkyl tin carboxylates, oxides and mercaptides. Specific examples include triethylenediamine, 1,4-diazabicyclo[2.2.2]octane, dimethylcyclohexylamine, dimethylethanolamine, and bis-(2-dimethylaminoethyl)ether, dibutyltin dilaurate, stannous octoate, with stannous octoate being particularly preferred.

Polymerization may be carried out in the presence of a plasticizer, such as a high boiling ester or diester, for example a dialkyl phthalate. Diisononyl phthalate is particularly preferred.

An example of a method for manufacturing the polyurethane prepolymer comprised the following steps:
1. the at least one polyether polyol is heated to 45-65° C. under an inert atmosphere (e.g. nitrogen or argon), optionally in the presence of a plasticizer (e.g. diisononyl phthalate);
2. the polyisocyanate is added;
3. the catalyst is added;
4. after reaction, if desired, a second amount of plasticizer may be added (e.g. diisononyl phthalate), and a stabilizer, such as dialkyl malonate (e.g. diethyl malonate).

In a preferred embodiment, the method of manufacture of the polyurethane prepolymer comprises the following steps:
1. polyether diol and polyether triol are heated to 45-65° C. under an inert atmosphere (e.g. nitrogen or argon), optionally in the presence of a plasticizer (e.g. diisononyl phthalate);
2. MDI is added, and the mixture is stirred until homogeneous;
3. the catalyst stannous octoate is added, slowly, preferably dropwise;
4. the mixture is held at 75-85° C., and diisononyl phthalate is added, together with diethyl malonate.

In a preferred embodiment, the polyurethane prepolymer comprises 18 to 30 wt % polyol diol, more preferably 19 to 25 wt %, more particularly preferably 22 to 23 wt %, based on the total weight of the prepolymer.

In a preferred embodiment, the polyurethane prepolymer comprises 25 to 40 wt % polyol triol, 28 to 35 wt %, more particularly preferably 32 to 33 wt %, based on the total weight of the prepolymer.

In a preferred embodiment, the polyurethane prepolymer comprises 5 to 15 wt % diisocyanate, more preferably 8 to 12 wt %, more particularly preferably 9 to 11 wt %, based on the total weight of the prepolymer.

In a particularly preferred embodiment, the polyurethane prepolymer comprises 22 to 23 wt % polyol diol, 32 to 33 wt % polyol triol, and 9 to 11 wt % diisocyanate, based on the total weight of the prepolymer.

In a preferred embodiment, the polyurethane prepolymer comprises 18 to 30 wt % of a nominally difunctional, poly(propylene oxide) having a hydroxyl number of 56 (equivalent weight 1000), more preferably 19 to 25 wt %, more particularly preferably 22 to 23 wt %, based on the total weight of the prepolymer.

In a preferred embodiment, the polyurethane prepolymer comprises 25 to 40 wt % of a nominally trifunctional poly(propylene oxide) having a hydroxyl number of 36 (equivalent weight 1558), 28 to 35 wt %, more particularly preferably 32 to 33 wt %, based on the total weight of the prepolymer.

In a preferred embodiment, the polyurethane prepolymer comprises 5 to 15 wt % MDI, more preferably 8 to 12 wt %, more particularly preferably 9 to 11 wt %, based on the total weight of the prepolymer.

In a particularly preferred embodiment, the polyurethane prepolymer comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of the prepolymer.

In a preferred embodiment, the polyether prepolymer has an isocyanate content of 1.25% by weight.

In a preferred embodiment, the polyurethane prepolymer has a viscosity of 16,000 cps at 23° C. as measured according to the procedure described in U.S. Pat. No. 5,922,809 at column 12, lines 38 to 49.

In a particularly preferred embodiment, the polyurethane prepolymer has an isocyanate content of 1.25% by weight, and a viscosity of 16,000 cps at 23° C. as measured according to the procedure described in U.S. Pat. No. 5,922,809 at column 12, lines 38 to 49.

In a particularly preferred embodiment, the polyurethane prepolymer comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of the prepolymer, and has an isocyanate content of 1.25% by weight, and a viscosity of 16,000 cps at 23° C. as measured according to the procedure described in U.S. Pat. No. 5,922,809 at column 12, lines 38 to 49.

The polyurethane prepolymer is preferably present in the one-component polyurethane adhesive at 20-70 wt %, more preferably 30-55 wt %, more particularly preferably 35 to 40 wt % based on the total weight of the adhesive.

In a particularly preferred embodiment, the adhesive composition of the invention comprises 20-70 wt %, more preferably 35 to 40 wt % of a polyurethane prepolymer, based on the total weight of the adhesive composition, comprising a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI, and having an isocyanate content of 1.25% by weight.

If used, the polyester prepolymer is present at 0.5 to 5 wt %, more preferably 0.75 to 1.5 wt %, based on the total weight of the adhesive.

Preferably, the polyether based prepolymer or prepolymer mixture has a Brookfield viscosity of at least 6,000 centipoise or at least about 8,000 centipoise, and as much as 30,000 centipoise or as much as 20,000 centipoise. If the viscosity is too high, it will be difficult to pump the final adhesive. If the viscosity is too low, the final adhesive will be too runny and/or will sag.

The polyether prepolymer has an isocyanate equivalent weight of at least 840, which corresponds to an NCO content of 5% by weight. The isocyanate equivalent weight of the prepolymer may be at least 1050 (NCO content 4%), at least 1400 (NCO content 3%) or at least 1680 (NCO content 2.5%), and may be up to, for example, 10,000 (NCO content 0.42%), up to 8400 (NCO content 0.5%), up to 7000 (NCO content 0.6%), up to 5000 (NCO content 0.84%).

The polyether prepolymer has an average isocyanate functionality of at least about 2.0 and molecular weights (weight average) of at least about 2,000. Preferably, the average isocyanate functionality of the prepolymer is at least about 2.2, and is more preferably at least about 2.4. Preferably, the isocyanate functionality is no greater than about 3.5, more preferably no greater than about 3.0 and most preferably no greater than about 2.8. Preferably, the weight average molecular weight of the prepolymer is at least about 1,000, is preferably at least about 2,500 and is more preferably at least about 3,000; and is preferably no greater than about 40,000, even more preferably no greater than about 20,000, more preferably no greater than about 15,000 and is most preferably no greater than about 10,000. The prepolymer may be prepared by any suitable method, such as by reacting an isocyanate-reactive compound containing at least two isocyanate-reactive, active hydrogen containing groups with an excess over stoichiometry of a polyisocyanate under reaction conditions sufficient to form the corresponding prepolymer.

Prepolymer equivalent and molecular weights are determined according to the procedure disclosed in U.S. Pat. No. 5,922,809 at column 12, lines 50 to 64, incorporated herein by reference.

Amine and/or Organometallic Catalyst (B)

The one-component polyurethane adhesive of the invention comprises at least one amine catalyst and optionally at least one organometallic catalyst. The catalysts are those that are capable of catalysing the reaction of an isocyanate with moisture.

The amine catalyst is any amine catalyst capable of catalysing the reaction of an isocyanate with moisture. Preferred are tertiary amines, for example aliphatic cyclic and non-cyclic tertiary amines, such as N,N-dimethylcyclohexaneamine, triethylenediamine, N,N,N,N-tetramethylalkylenediamine, N,N,N, N-pentamethyldiethylenetriamine, triethylamine, N,N-dimethylbenzylamine, N,N-dimethylhexadecylamine, N,N-dimethylbutylamine, di(2,6-dimethylmorpholinoethyl) ether, 2,2′-dimorpholinodiethyl ether.

Particularly preferred is 2,2′-dimorpholinodiethyl ether.

The amine catalyst is preferably used at 0.05 to 2 wt %, more preferably 0.1 to 1 wt %, based on the total weight of the adhesive.

In a preferred embodiment, the amine catalyst is 2,2′-dimorpholinodiethyl ether, used at 0.1 to 1 wt % based on the total weight of the adhesive composition.

If an organometallic catalyst is used, it is any organometallic catalyst capable of catalyzing the reaction of isocyanate with a functional group having at least one reactive hydrogen. Examples include metal carboxylates such as tin carboxylate and zinc carboxylate. Metal alkanoates include stannous octoate, bismuth octoate or bismuth neodecanoate. Preferably the at least one organometallic catalyst is an organotin catalyst. Examples include dibutyltin dilaurate, stannous octoate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a particularly preferred embodiment, it is dimethyl tin dineodecanoate. The organometallic catalyst is preferably present at 0.001-2 wt %, more preferably 0.005-1 wt %, particularly preferably at 0.01 to 0.5 wt %, based on the total weight of the adhesive.

### Flame Retardants/Synergists

The one-component polyurethane adhesive of the invention contains the flame retardants/synergists aluminium hydroxide, melamine polyphosphate and aluminium diethylphosphinate.

The aluminium hydroxide preferably has a median particle size of 2.6 microns.

The aluminium hydroxide is preferably present at 15 to 30 wt %, more preferably 20 to 28 wt %, particularly preferably 25 wt %, based on the total weight of the adhesive.

The melamine polyphosphate preferably has a mean particle diameter of less than 20 microns, more preferably 15 microns or less, more particularly preferably 10 microns or less, as measured using laser diffraction technology with a Malvern Mastersizer 2000 particle size analyser instrument, in acetone. In a particularly preferred embodiment, the melamine polyphosphate has a D₅₀ of 3-10 microns, more preferably 5 microns.

The melamine polyphosphate is preferably present at 10 to 20 wt %, more preferably 12 to 15 wt %, particularly preferably 13 wt %, based on the total weight of the adhesive.

The aluminium diethylphosphinate preferably has a D₅₀ (volume %, measured using laser diffraction technology with a Malvern Mastersizer 2000 particle size analyser instrument, in acetone) of ≤ 40 microns, and/or a D₉₅ of ≤ 10 microns.

The aluminium diethylphosphinate is preferably present at 2 to 10 wt %, more preferably 2.5 to 5 wt %, particularly preferably at 3.5 or 4.5 wt %, based on the total weight of the adhesive.

In a preferred embodiment, the adhesive comprises 2.5 to 5 wt % of aluminium diethylphosphinate having a D₅₀ (volume %, measured using laser diffraction technology with a Malvern Mastersizer 2000 particle size analyser instrument, in acetone) of ≤ 40 microns, and/or a D₉₅ of ≤ 10 microns.

In a preferred embodiment, the adhesive comprises 20 to 28 wt % aluminium hydroxide, 12 to 15 wt % melamine polyphosphate, and 2.5 to 5 wt % aluminium diethylphosphinate, based on the total weight of the adhesive.

In a particularly preferred embodiment, the adhesive comprises aluminium hydroxide preferably having a median particle size of 2.6 microns at 20 to 28 wt %, melamine polyphosphate having a mean particle diameter of less than 20 microns, more preferably 15 microns or less, more particularly preferably 10 microns or less, as measured using laser diffraction technology with a Malvern Mastersizer 2000 particle size analyser instrument, in acetone at 12 to 15 wt %, and aluminium diethylphosphinate having a D₅₀ (volume %, measured using laser diffraction technology with a Malvern Mastersizer 2000 particle size analyser instrument, in acetone) of ≤ 40 microns and/or a D₉₅ of ≤ 10 microns at 2.5 to 5 wt %, based on the total weight of the adhesive.

### Optional Ingredients (D)

The adhesive compositions of the invention may comprise carbon black at 1-20 wt %, more preferably 2 to 10 wt %, based on the total weight of the adhesive composition.

The carbon black is not particularly limited. Preferred carbon blacks exhibit an oil absorption number of at least 80, preferably at least 90 and more preferably at least 95 cm³ of dibutyl phthalate per 100 g of carbon black, as measured according to ASTM D-2414-09. In addition, the carbon black desirably has an iodine number of at least 80, determined according to ASTM D1510-11.

The adhesive compositions of the invention optionally comprise calcium carbonate at 0-20 wt %, more preferably 5 to 15 wt %, particularly preferably 9-10 wt %, based on the total weight of the adhesive composition. The calcium carbonate particles may be untreated or surface modified by treatment with chemicals, such as organic acids or esters of organic acids.

The adhesive compositions of the invention may optionally comprise fumed silica at 0-1.5 wt %, more preferably 0.5 to 1 wt %, based on the total weight of the adhesive.

If fumed silica is used, the particles may be untreated or surface modified by treatment with chemicals, such as chlorosilane, dichlorosilane, alkyltrialkoxysilane or polydimethylsiloxane.

### Other Optional Ingredients

The adhesive compositions of the invention may additionally comprise other ingredients, such as, for example, one or more plasticizers (such as diisononyl phthalate), one or more stabilizers, for example heat, visible light and UV-stabilizers.

Examples of heat stabilizers include alkyl substituted phenols, phosphites, sebacates and cinnamates. If present, a preferred heat stabilizer is an organophosphite and more specifically trisnonylphenyl phosphite as disclosed in U.S. Pat. No. 6,512,033, incorporated herein by reference. The heat stabilizer may constitute at least 0.01 or at least 0.3 weight percent based on the entire weight of the adhesive composition, up to at most 5 weight percent, up to 2 weight percent or up to 1.0 weight percent. The adhesive composition may be devoid of such a heat stabilizer.

For UV light stabilizers, they include benzophenones and benzotriazoles. Specific UV light absorbers include those from BASF such as TINUVIN™ P, TINUVIN™ 326, TINUVIN™ 213, TINUVIN™ 327, TINUVIN™ 571, TINUVIN™ 328, and from Cytec such as CYASORB™ UV-9, CYASORB™ UV-24, CYASORB™ UV-1164, CYASORB™ UV-2337, CYASORB™ UV-2908, CYASORB™ UV-5337, CYASORB™ UV-531, and CYASORB™ UV-3638. Among these, TINUVIN™ 571 is preferred. One or more UV light absorbers may constitute at least 0.1 weight percent, at least 0.2 weight percent or at least 0.3 parts by weight of the weight of the adhesive composition, and may constitute up to 3 weight percent, up to 2 weight percent or up to 1 weight percent thereof.

The adhesive composition of the invention may further include one or more visible light stabilizers. Preferred visible light stabilizers included hindered amine visible light stabilizers such as TINUVIN™ 144, TINUVIN™ 622, TINUVIN™ 77, TINUVIN™ 123, TINUVIN™ 765, CHIMASSORB™ 944 available from Cytec; CYASORB™ UV-500, CYASORB™ UV-3581, CYASORB™ UV-3346, all available from Ciba-Geigy. Among these, TINUVIN™ 765 is preferred choice. The visible light stabilizer(s) may constitute at least 0.1 weight percent, at least 0.2 weight percent or at least 0.3 weight percent of the adhesive composition, and may constitute up to 3 weight percent, up to 2 weight percent or up to 1.5 weight percent thereof.

In a preferred embodiment, the stabilizers comprise trisnonylphenyl phosphite, bis(1,2,2,6,6-pentamethyl-4-piperidyl)sebecate and methyl 1,2,2,6,6-pentamethyl-4-piperidyl sebecate, 2-(2H-benzotriazo-2-yl)-6-dodecyl-4-methyl-Phenol and mixtures of these, it is particularly preferred to use a mixture of these.

NCO stabilizers may also be added, for example, malonate diesters, such as diethyl malonate.

### Method of Manufacture

The adhesive compositions of the invention are made by mixing the ingredients under inert and dry conditions and/or under vacuum, until a homogenous mixture is obtained.

The resulting adhesive composition may be packaged, for example, it may be packaged into airtight containers, such as airtight tubes which are stored in nitrogen filled sealed aluminium bags.

### Method of Use

In a second aspect, the invention provides a method for adhering two substrates, comprising the steps:
(1) providing a one-component, moisture-curable polyurethane adhesive according to the invention;
(2) applying the adhesive to a first substrate, a second substrate, or both;
(3) placing the first and second substrates in adhesive contact, whereby the adhesive is sandwiched between them; and
(4) allowing the adhesive to cure.

As mentioned above, a preferred way of providing the adhesive of the invention is in airtight containers, such as airtight sealed tubes. The containers are opened immediately prior to use.

The adhesive of the invention may be applied by any application method, including, for example, in bead form with a pressurized flow gun through a nozzle. It can be applied manually or robotically.

In a preferred embodiment one or both of the first and second substrates are metal, in particular coated or non-coated steel or aluminum. In a particularly preferred embodiment, both substrates are electric coated steel.

Curing is carried out by exposing the adhesive to atmospheric moisture. Curing may take place at room temperature, or at elevated temperature, for example, 50° C. or greater or 70° C. or greater. Typical curing conditions include 3 to 7 days at 23° C. and 50% RH, as well as 7 to 14 days at 80° C.

### Effect of the Invention

The adhesives of the invention show good adhesive properties. Using the quick knife adhesion test described in the Examples, the adhesives of the invention, after curing for 7 days at 23° C., 50% RH, preferably show a failure mode of greater than 90% cohesive failure, more preferably greater than 95% cohesive failure, more particularly preferably 100% cohesive failure.

Using the lap shear strength test described in the Examples, the adhesives of the invention, after curing for 7 days at 23° C. and 50% RH, preferably show a lap shear strength of 360 psi or greater, more preferably 370 psi or greater. Using the same test, the adhesives of the invention, after curing for 7 days at 50% RH, preferably show a failure mode of greater than 90% cohesive failure, more preferably greater than 95% cohesive failure, more particularly preferably 100% cohesive failure.

Using the lap shear strength test described in the Examples, the adhesives of the invention, after curing for 7 days at 23° C. and 50% RH plus 14 days at 80° C., preferably show a lap shear strength of 400 psi or greater, more preferably 410 psi or greater. Using the same test, the adhesives of the invention, after curing for 7 days at 23° C. and 50% RH plus 14 days at 80° C., preferably show a failure mode of greater than 90% cohesive failure, more preferably greater than 95% cohesive failure, more particularly preferably 100% cohesive failure.

The adhesives of the invention show good flame-retardancy. Using the vertical burn test described in the Examples, the adhesives of the invention (after curing for 7 days at 23° C. and 50% RH) preferably show an extinguishing time after the first 10 second burn of less than 2 seconds, more preferably less than 1 second, particularly preferably 0 seconds. The adhesives of the invention preferably show an extinguishing time after the second 10 second burn of less than 6 seconds, more preferably 4 seconds or less.

The adhesives of the invention preferably show a UL94 rating of V0 (after curing for 7 days at 23° C. and 50% RH).

The uncured adhesives of the invention also show reduced sag. Using the sag test described in the Examples, the adhesives of the invention preferably show a sag of less than 2 mm, more preferably less than 1 mm, more particularly preferably 0 mm, when tested immediately after adhesive preparation. The adhesives of the invention preferably show a sag of less than 3 mm, more preferably 2 mm or less, when tested after they are heat-aged under moisture-free conditions at 54° C. for 3 days. This demonstrates that the adhesives of the invention are relatively storage stable, when stored under moisture-free conditions, even at elevated temperatures.

The adhesives of the invention show high electrical resistivity. Using the resistivity test described in the Examples, the adhesives of the invention preferably show a resistivity of >10⁶Ω (after curing for 7 days at 23° C. and 50% RH).

### Use

The adhesive compositions of the invention are particularly suited for adhering substrates in environments in which flame retardancy performance is required. Particular examples include areas adjacent to the fuel tank in internal combustion engine automobiles, and in battery assemblies for bonding and sealing, in particular in the area around battery box where flame-retardancy is particularly required.

### Particularly Preferred Embodiments

The following are particularly preferred embodiments of the adhesive compositions of the invention:
1. A one-component, moisture-curable polyurethane adhesive comprising:
   (A) at least one polyurethane prepolymer;
   (B) at least one amine catalyst and optionally an organometallic catalyst;
   (C) the flame retardants/synergists aluminium hydroxide, melamine polyphosphate and aluminium diethylphosphinate; and
   (D) optionally adhesion promoters, fillers.
2. The adhesive of embodiment 1, wherein the at least one polyurethane prepolymer is made by polymerizing at least one polyether polyol and/or polyester polyol in the presence of a polyisocyanate.
3. The adhesive of embodiment 2, wherein the at least one polyetherpolyol is a poly(C₂-C₆-alkylene oxide)diol.
4. The adhesive of embodiment 2 or 3, wherein the at least one polyetherpolyol is a poly(C₂-C₄-alkylene oxide)diol.
5. The adhesive of embodiment 2, 3 or 4, wherein the at least one polyetherpolyol is selected from poly(propylene oxide) diols, poly(propylene oxide) triols, and mixtures of these.
6. The adhesive of any one preceding embodiment, wherein the at least one polyurethane prepolymer is a mixture of a polyether polyol-based prepolymer and a polyester polyol-based prepolymer.
7. The adhesive of any one preceding embodiment, wherein the at least one polyurethane prepolymer is made by reacting a poly(propylene oxide) diol, a poly(propylene oxide) triol and a diisocyanate.
8. The adhesive of any one preceding embodiment, wherein the at least one polyurethane prepolymer is a mixture of a prepolymer made by reacting a poly(propylene oxide) diol, a poly(propylene oxide) triol and a diisocyanate, and a prepolymer made by reacting an aliphatic polyester diol with a diisocyanate.
9. The adhesive of embodiment 7 or 8, wherein the diisocyanate is selected from IPDI, MDI, and mixtures of these.
10. The adhesive of any one preceding embodiment, wherein the polyurethane prepolymer is present at 20-70 wt %, more preferably 35 to 40 wt % of a polyurethane prepolymer, based on the total weight of the adhesive composition.
11. The adhesive of any one preceding embodiment, which comprises 20-70 wt %, more preferably 35 to 40 wt % of a polyurethane prepolymer, based on the total weight of the adhesive composition, comprising a nominally trifunctional poly(propylene oxide) having a hydroxyl number of 36 (equivalent weight 1558) and a nominally difunctional poly(propylene oxide) having a hydroxyl number of 56 (equivalent weight 1000), reacted with MDI, and having an isocyanate content of 1.25% by weight.
12. The adhesive of any one preceding embodiment, wherein the at least one polyurethane prepolymer comprises a prepolymer made by reacting an aliphatic polyester diol with a diisocyanate, at 0.5 to 5 wt %, more preferably 0.75 to 2.0 wt %, based on the total weight of the adhesive.
13. The adhesive of any one preceding embodiment, wherein the amine catalyst is selected from aliphatic cyclic and non-cyclic tertiary amines.
14. The adhesive of any one preceding embodiment, wherein the amine catalyst is selected from N,N-dimethylcyclohexaneamine, triethylenediamine, N,N,N,N-tetramethylalkylenediamine, N,N,N,N-pentamethyldiethylenetriamine, triethylamine, N,N-dimethylbenzylamine, N, N-dimethylhexadecylamine, N,N-dimethylbutylamine, di(2,6-dimethylmorpholinoethyl) ether, and 2,2′-dimorpholinodiethyl ether.
15. The adhesive of any one preceding embodiment, wherein the amine catalyst is 2,2′-dimorpholinodiethyl ether.
16. The adhesive of any one preceding embodiment, wherein the amine catalyst is used at 0.1 to 1 wt %, based on the total weight of the adhesive composition.
17. The adhesive of any one preceding embodiment, wherein the aluminium hydroxide has a median particle size of 2.6 micron.
18. The adhesive of any one preceding embodiment, wherein the melamine polyphosphate has a D₅₀ of 20 microns, preferably a D₅₀ of 15 microns, more preferably a D₅₀ of 5 microns as measured using laser diffraction technology with a Malvern Mastersizer 2000 particle size analyser instrument, in acetone.
19. The adhesive of any one preceding embodiment, wherein the aluminium diethylphosphinate preferably has a D₅₀ of ≤ 40 microns and/or a D₉₅ (volume %, measured using laser diffraction technology with a Malvern Mastersizer 2000 particle size analyser instrument, in acetone) of ≤ 10 microns.
20. The adhesive of any one preceding embodiment, wherein the aluminium hydroxide is present at 15 to 30 wt %, based on the total weight of the adhesive.
21. The adhesive of any one preceding embodiment, wherein the aluminium hydroxide is present at 20 to 28 wt %, based on the total weight of the adhesive.
22. The adhesive of any one preceding embodiment, wherein the aluminium hydroxide is present at 25 wt %, based on the total weight of the adhesive.
23. The adhesive of any one preceding embodiment, wherein the melamine polyphosphate is present at 10 to 20 wt %, based on the total weight of the adhesive.
24. The adhesive of any one preceding embodiment, wherein the melamine polyphosphate is present at 12 to 15 wt %, based on the total weight of the adhesive.
25. The adhesive of any one preceding embodiment, wherein the melamine polyphosphate is present at 13 wt %, based on the total weight of the adhesive.
26. The adhesive of any one preceding embodiment, wherein the aluminium diethylphosphinate is present at 2 to 10 wt %, based on the total weight of the adhesive.
27. The adhesive of any one preceding embodiment, wherein the aluminium diethylphosphinate is present at 2.5 to 5 wt %, based on the total weight of the adhesive.
28. The adhesive of any one preceding embodiment, wherein the aluminium diethylphosphinate is present at 3.5 or 4.5 wt %, based on the total weight of the adhesive.
29. The adhesive of any one preceding embodiment, which additionally comprises carbon black.
30. The adhesive of any one preceding embodiment, which additionally comprises carbon black at 1-20 wt %, more preferably 2 to 10 wt %, based on the total weight of the adhesive composition.
31. The adhesive of any one preceding embodiment, which additionally comprises calcium carbonate.
32. The adhesive of any one preceding embodiment, which additionally comprises fumed silica.
33. The adhesive of any one preceding embodiment, which additionally comprises fumed silica surface-treated with chlorosilane, dichlorosilane, alkyltrialkoxysilane or polydimethylsiloxane.)
34. The adhesive of any one preceding embodiment, which in the quick knife adhesion test (described herein) after curing for 7 days at 23° C. and 50% RH, show a failure mode of greater than 90% cohesive failure (CF), more preferably greater than 95% cohesive failure, more particularly preferably 100% cohesive failure.
35. The adhesive of any one preceding embodiment, which in the lap shear strength test (described herein) after curing for 7 days at 23° C. and 50% RH, show a lap shear strength of 360 psi or greater, more preferably 370 psi or greater.
36. The adhesive of any one preceding embodiment, which in the lap shear strength test (described herein) after curing for 7 days at 23° C. and 50% RH, show a failure mode of greater than 90% cohesive failure, more preferably greater than 95% cohesive failure, more particularly preferably 100% cohesive failure.
37. The adhesive of any one preceding embodiment, which, using the vertical burn test described herein, after curing for 7 days at 23° C. and 50% RH show an extinguishing time after the first 10 second burn of less than 2 seconds, more preferably less than 1 second, particularly preferably 0 seconds.
38. The adhesive of any one preceding embodiment, which, using the vertical burn test described herein, after curing for 7 days at 23° C. and 50% RH show an extinguishing time after the second 10 second burn of less than 6 seconds, more preferably 4 seconds or less.
39. The adhesive of any one preceding embodiment, which, using the sag test described herein, show a sag of less than 2 mm, more preferably less than 1 mm, more particularly preferably 0 mm, when tested immediately after manufacture.
40. The adhesive of any one preceding embodiment, which, using the sag test described herein, show a sag of less than 3 mm, more preferably 2 mm or less, when tested after heat-ageing under moisture-free conditions at 54° C. for 3 days.
41. The adhesive of any one preceding embodiment, which, using the resistivity test described herein, show a resistivity of >10⁶Ω after curing for 7 days at 23° C. and 50% RH.

42. The adhesive of any one preceding embodiment, which shows a UL94 rating of V0 (after curing for 7 days at 23° C. and 50% RH).
43. A method for adhering two substrates, comprising the steps:
   (1) providing a one-component, moisture-curable polyurethane adhesive according to any one preceding embodiment;
   (2) applying the adhesive to a first substrate, a second substrate, or both;
   (3) placing the first and second substrates in adhesive contact, whereby the adhesive is sandwiched between them; and
   (4) allowing the adhesive to cure.
44. The method of embodiment 43, wherein the first and second substrate are independently selected from metals.
45. The method of embodiment 43, wherein the first and second substrate are independently selected from coated steel and aluminium.
46. The method of embodiment 43, 44 or 45, wherein curing is carried out at room temperature.

### Examples

TABLE 1
Ingredients

| Trademark or | | |
|---|---|---|
| abbreviation | Chemistry | Function |
| VORANOL 220-056N | a nominally difunctional, | Ingredient in polyether |
| POLYOL | poly(propylene oxide) having a | prepolymer |
| | hydroxyl number of 56 (equivalent | |
| | weight 1000) | |
| VORANOL 232-036N | a nominally trifunctional | Ingredient in polyether |
| POLYOL | poly(propylene oxide) having a | prepolymer |
| | hydroxyl number of 36 (equivalent | |
| | weight 1558) that is partially end- | |
| | capped with ethylene oxide | |
| MDI | 4,4′-Methylenebis(phenyl | Diisocyanate |
| | isocyanate) | |
| Dynacoll 7381 | Hydroxyl terminated saturated | Ingredient in polyester |
| | copolyester | prepolymer |
| Elftex S7100 | carbon black | Carbon Black Filler |
| Clay | Kaolin clay (calcined aluminium | Clay Filler |
| | silicate) | |
| Calcium carbonate | CaCO₃ | Calcium Carbonate Filler |
| Diisononyl phthalate | Diisononyl phthalate | Plasticizer |
| DMDEE | 2,2′-dimorpholinodiethylether | Amine catalyst |
| Desmodur N 3300 | Aliphatic polyisocyanate based on | Aliphatic polyisocyanate |
| | HDI trimer, having an isocyanate | |
| | functionality of greater than 2.5, an | |
| | isocyanate equivalent weight of | |
| | about 193, and an NCO content of | |
| | 21.8 ± 0.3% (according to DIN EN | |
| | ISO 11 909) | |
| HDI | Hexamethylene diisocyanate | Aliphatic polyisocyanate |
| PAPI 20 | Polymeric MDI, having an NCO | Aromatic polyisocyanate |
| | content of 30.4% (according to | |
| | DIN EN ISO 11 909), having an | |
| | isocyanate functionality of 3.2 and | |
| | an isocyanate equivalent weight of | |
| | about 138 | |
| Metacure T-9 | stannous octoate | Catalyst |
| Cabosil TS720 | Fumed silica surface treated with | Filler |
| | polydimethylsiloxane (PDMS). | |
| ATH | Aluminium hydroxide, Al(OH)₃ [a | Flame retardant/synergist |
| | median particle size 2.6 microns] | |
| MPP | Melamine polyphosphate, D50 of 5 | Flame retardant/synergist |
| | microns | |
| Exolit OP935 | Aluminium diethylphosphinate, D₉₅ | Flame retardant/synergist |
| | (volume %, measured using laser | |
| | diffraction technology with a | |
| | Malvern Mastersizer 2000 particle | |
| | size analyser instrument, in | |
| | acetone) of ≤10 microns. | |

### Preparation of Prepolymers

Prepolymer 1 and Prepolymer 2 were prepared using the ingredients listed in Table 2.

TABLE 2
Composition of Prepolymer 1 and Prepolymer 2

| Ingredient | Prepolymer 1 (wt %) | Prepolymer 2 (wt %) |
|---|---|---|
| Voranol 220-056 Polyol | 22.73 | — |
| diol | | |
| Voranol 232-036 Polyol | 32.94 | — |
| triol | | |
| Dynacol 7381 polyester | — | 71.70 |
| diol | | |
| diisononylphthalate (1^{st} | 2.00 | 17.50 |
| portion) | | |
| MDI | 10.04 | 17.50 |
| stannous octoate | 0.005 | — |
| diisononylphthalate (2^{nd} | 31.325 | — |
| portion) | | |
| Diethyl malonate | 0.96 | — |
| Viscosity at 23° C., cps | 16,000 | Paste at room |
| | | temperature |
| NCO wt % | 1.25 | 2.0 |

### Prepolymer 1

1. The diol and triol and diisononylphthalate (1st portion) were charged into a dry reaction flask, mixed and heated under nitrogen to 54° C.
2. The MDI was added when the temperature reached 54° C.
3. The stannous octoate was added drop-wise over 2 minutes.
4. The temperature rose and was held at 80° C. for 30 minutes.
5. The temperature was reduced to 60° C. The diisononylphthalate (2nd portion) was added, as well as the diethylmalonate and the mixture was stirred for 30 minutes. Get a sample for NCO.
6. The prepolymer was packaged under nitrogen.

### Prepolymer 2

1. The diisononylphthalate was charged into a dry reaction flask and heated under N₂ to 50° C.
2. The MDI was added when the temperature reached 50° C.
3. The molten polyester diol (Dynacoll 7381) was added into the above mixture slowly.
4. The mixture was allowed to react for 40 minutes under nitrogen at a temperature between 80° C. to 90° C.
5. The prepolymer was stored in a dry glass container (air tight).

### Preparation of Adhesive Compositions

The ingredients listed in Table 3 were mixed to homogeneity under a moisture-free atmosphere (under vacuum), and packaged into air tight tubes which were stored in nitrogen filled sealed aluminium bags.

Inventive Examples are designated “E1” and “E2”, and comparative Examples are designated “CE1” and “CE2”.

### Test Methods

### Quick Knife Adhesion Test (QKA)

The quick knife adhesion test (QKA) was performed by dispensing a bead of 6 mm (width)×6 mm (height)×100 mm (length) in size on the tested substrate. The quick knife test was run after the initial cure of the bead under 23° C. and 50% RH (relative humidity) for a specific time period and any further environmental exposure. When tested, a slit (20-40 mm) was cut between the substrate and the end of adhesive bead. The cured adhesive bead was then cut with a razor blade through to the tested substrate at a 60 degree angle while pulling back the end of the bead at >90 degree angle. Notches were cut about every 3-5 mm on the substrate. The degree of adhesion was evaluated as adhesive failure (AF), thin film failure (TF) and/or cohesive failure (CF). In case of AF, the cured bead can be separated from the tested substrate surface, while in CF, separation occurs within the adhesive bead as a result of cutting and pulling and TF is a special case of CF in which there is a thin film of cured adhesive left on the substrate after cutting and testing.

The results for Inventive Examples 1 and 2 are listed in Table 4.

### Press Flow Viscosity

The press flow viscosity on the adhesive sample was determined by recording the amount of time (in seconds) for 20 grams of the adhesive composition to pass through a 4.0 mm orifice under conditions of 552 kPa applied pressure at 23° C., unless otherwise specified.

Results are listed in Table 5.

### Sag

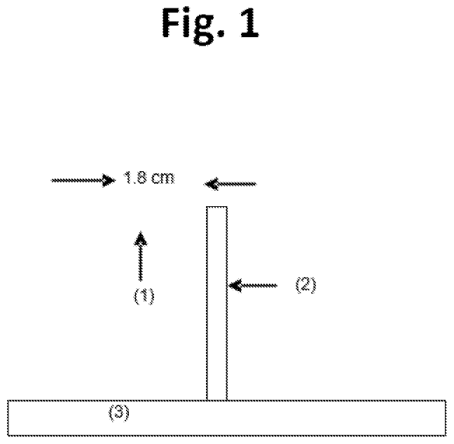

Sag performance was evaluated by the following method. A metal panel of 10 cm height and 30 cm long was placed vertically by its length. The adhesive composition, which was either from fresh preparation or after heat ageing for 3 days at 54° C. in a nitrogen filled aluminium bag, was dispensed as a right angle triangular bead along the top edge of the panel with a height of 1.8 cm and a base of 0.6 cm [as shown in FIG. 1, where (1) is the adhesive bead, (2) is the panel and (3) is the bench]. After 30 minutes, the amount of drop or sag of the tip of the adhesive bead from its original position was measured in millimeters. If there was no sag from the bead tip, then the sag test result was reported as zero millimeter.

Results are listed in Table 5.

### Lap Shear Test

The lap shear test was performed according to SAE J1529 test procedure which is described below. A triangle bead of adhesive composition approximately 7 mm base and 9 mm height was applied along the width of the 25 mm by 100 mm of a specified coupon and about 6 mm away from the coupon end. The second substrate, which can be a coated metal coupon, was immediately pressed on the adhesive bead to give a final height of 6 mm for the composition in between. The sample was allowed to cure under conditions of 23° C. and 50% relative humidity (RH) for 7 days unless specified otherwise. The sample was then pulled right away or after more environmental exposures at a rate of 50 mm/min with an Instron Tester. The load (lbs) at sample break divided by the sample area (in²) gives the lap shear adhesion strength (psi). The degree of adhesion is evaluated as adhesive failure (AF), thin film failure (TF) and/or cohesive failure (CF). In case of AF, the cured bead can be separated from the tested substrate surface, while in CF, separation occurs within the sealant adhesive and TF is a special case of CF in which there is a thin film of cured adhesive left on the substrate after testing.

Results are listed in Table 6.

### Tensile and Elongation Properties

Adhesive samples were dispensed between two releasing papers and then pressed to form round patties with 3 mm thickness. These round patties were cured for 7 days at conditions of 23° C. and 50% relative humidity (RH). Test specimens were cut from these cured sample patties and tested for, tensile strength, elongation and Young's modulus (from 1% to 10% strain) with an Instron Tester, all according to ASTM D412 (Die C).

Results are listed in Table 7.

TABLE 3
Ingredients in comparative and inventive adhesives

| Ingredient | CE1 | CE2 | E1 | E2 |
|---|---|---|---|---|
| Prepolymer 1 | 39.42 | 42.80 | 37.92 | 37.22 |
| (wt %) | | | | |
| Prepolymer 2 | 1.00 | — | 1.00 | 1.00 |
| (wt %) | | | | |
| Diisononyl | 3.30 | — | 3.30 | 3.30 |
| phthalate (wt %) | | | | |
| Desmodur N3300 | 1.00 | — | 1.00 | 1.00 |
| (wt %) | | | | |
| PAPI 20 (wt %) | — | 0.80 | — | — |
| DMDEE (wt %) | 0.18 | 0.40 | 0.18 | 0.18 |
| Fumed silica | 0.80 | 5.00 | 0.80 | 0.80 |
| (wt %) | | | | |
| ATH (wt %) | 25.00 | 50.00 | 25.00 | 25.00 |
| MPP (wt %) | 13.00 | — | 13.00 | 13.00 |
| Carbon black | 6.30 | 1.00 | 6.30 | 6.00 |
| (wt %) | | | | |
| Exolit OP935 | — | — | 3.50 | 4.50 |
| (wt %) | | | | |
| CaCO₃ (wt %) | 10.00 | — | 8.00 | 8.00 |

### Electrical Resistivity

Two copper strips (50 mm in length and 12 mm in width) were set in parallel on a nonconductive surface such as a cardboard with 50 mm between them. A triangle adhesive bead (6 mm base and 12 mm height) was dispensed perpendicularly to the two copper strips, passing through the middle of the strips. The bead was cured for 3 days (or a specific time) at 23° C. and 50% relative humidity. The resistivity of the bead was determined with an electric multi-meter by contacting its two probes with the two copper strips.

Results are listed in Table 8.

### Vertical Burning Test Method

An adhesive sample was dispensed between two releasing papers and then pressed to form a round patty with 4 mm (or specified) thickness. The patty was cured for 7 days at conditions of 23° C. and 50% relative humidity (RH). Three test specimens of 13 mm in width and 125 mm in length were cut from the cured round patty. In the vertical burning test, the first specimen is arranged in a vertical position with its upper end fixed in a clip. A propane torch is ignited, and its flame is adjusted about 25 mm tall. The torch flame is set vertically and is brought underneath the test specimen lower end with about 12 mm overlap. After 10 seconds burning, the flame is quickly removed, and the timer starts to count the time for the flame to extinguish from the specimen (this is defined as extinguish time after first burn). The same specimen is burnt in same fashion a second time for 10 seconds and the time for flame to extinguish is recorded again (extinguish time after second burn). a total of three specimens were tested from one adhesive sample. Overall short extinguish times from both first and second burn indicate good flame retardancy of the tested sample.

Results are listed in Table 9.

### UL94 V0 Flammability Test

An adhesive sample was dispensed between two releasing papers and then pressed to form a round patty with 4 mm (or specified) thickness. The patty was cured for 7 days at conditions of 23° ° C. and 50% relative humidity (RH). Ten test specimens of 13 mm in width and 125 mm in length were cut from the cured round patty. The first set of 5 specimens was tested according to UL94 V0 conditions. The second set of 5 specimens was further conditioned at 70ºC for 168 hours and then tested according to UL94 V0 conditions. If the test results of both sets of specimens met the UL94 V0 criteria, the adhesive sample was rated as passing the UL94 V0 requirement.

Results are listed in Table 10.

TABLE 4
Quick knife adhesion (QKA) results
for inventive Examples 1 and 2

| Sample | E1 | E2 |
|---|---|---|
| QKA, e-coat metal coupon, | | |
| naphtha cleaned | | |
| 7 day cure (23° C., 50% RH) | 100% CF | 100% CF |
| 7 day cure (23° C., 50% RH) plus 14 | 100% CF | 100% CF |
| day under 38° C., 100% RH | | |
| QKA, carbamate coated metal | | |
| coupon, naphtha cleaned | | |
| 7 day cure (23° C., 50% RH) | 100% CF | 100% CF |
| 7 day cure (23° C., 50% RH) plus 14 | 100% CF | 100% CF |
| day under 38° C., 100% RH | | |

TABLE 5
Press flow viscosity and sag for Comparative
Examples and Inventive Examples

| | CE1 | CE2 | E1 | E2 |
|---|---|---|---|---|
| Press flow | 26 | 68 | 38 | 41 |
| viscosity | | | | |
| immediately after | | | | |
| preparation (s per | | | | |
| 20 g) | | | | |
| Press flow | 32 | 148 | 49 | 51 |
| viscosity after | | | | |
| heat-ageing at | | | | |
| 54° C. for 3 days | | | | |
| (moisture free) (s | | | | |
| per 20 g) | | | | |
| Sag (mm) | 4 | 20 | 0 | 0 |
| immediately after | | | | |
| preparation | | | | |
| Sag (mm) after | 7 | Bead | 2 | 2 |
| heat-ageing at | | collapsed | | |
| 54° C. for 3 days | | | | |
| (moisture free) | | | | |

TABLE 6
Lap shear results for inventive Examples 1 and 2

| Sample | E1 | E2 |
|---|---|---|
| lapshear, e-coat metal coupon/e- | | |
| coat metal coupon, naphtha | | |
| cleaned | | |
| 7 day cure in 23° C., 50% RH | 371 psi/100% CF | 378 psi/100% CF |
| (strength/failure mode) | | |
| 7 day cure in 23° C., 50% RH plus | 414 psi/100% CF | 418 psi/100% CF |
| 14 day at 80° C. (strength/failure | | |
| mode) | | |

TABLE 7
Tensile strength, elongation at break and Young's modulus for samples

| Sample | E1 | | E2 | | CE1 | | CE2 | |
|---|---|---|---|---|---|---|---|---|
| after 7 d cure at 23° C., 50% RH | | | | | | | | |
| Tensile strength, psi | 573 | psi | 570 | psi | 550 | psi | 539 | psi |
| Elongation. % | 248% | | 266% | | 335% | | 358% | |
| Young's Modulus (1-10%) | 7.04 | MPa | 7.31 | MPa | 6.33 | MPa | 5.23 | MPa |

TABLE 8
Electrical resistivity of inventive Examples 1 and 2

| Sample | Example 1 | Example 2 |
|---|---|---|
| Resistivity, Ohm | >10⁶ | >10⁶ |
| after 3 day cure at 23° C., | | |
| 50% RH | | |

TABLE 9
Vertical burn test for samples

| sample ID | CE1 | | CE2 | | E1 | | E2 | |
|---|---|---|---|---|---|---|---|---|
| sample dimension | | | | | | | | |
| for burning testing | | | | | | | | |
| (width × length × | 13 mm × | | 13 mm × | | 13 mm × | | 13 mm × | |
| thickness) | 125 mm × | | 125 mm × | | 125 mm × | | 125 mm × | |
| | 4 mm | | 4 mm | | 4 mm | | 4 mm | |
| Vertical burning test: | | | | | | | | |
| first specimen | | | | | | | | |
| extinguish time after | 1 | second | 27 | seconds | 0 | second | 0 | second |
| first 10-second burn | | | | | | | | |
| extinguish time after | 23 | seconds | 49 | seconds | 4 | seconds | 2 | seconds |
| second 10-second burn | | | | | | | | |
| second specimen | | | | | | | | |
| extinguish time after | 4 | seconds | 20 | seconds | 0 | second | 0 | second |
| first 10-second burn | | | | | | | | |
| extinguish time after | 28 | seconds | 66 | seconds | 3 | seconds | 3 | seconds |
| second 10-second burn | | | | | | | | |

| | | | | | | | |
|---|---|---|---|---|---|---|---|
| third specimen | | | | | | | |
| extinguish time after | 2 | seconds | NA | 1 | second | 0 | second |
| first 10-second burn | | | | | | | |
| extinguish time after | 29 | seconds | NA | 4 | seconds | 4 | seconds |
| second 10-second burn | | | | | | | |

TABLE 10
UL94 burn test ratings for inventive Examples 1 and 2

| Sample | Example 1 | Example 2 |
|---|---|---|
| Rating | V0 | V0 |

### Discussion of Results

### Quick Knife Adhesion (QKA), Table 4.

Examples 1 and 2 both show 100% cohesive failure under the test conditions. This indicates that the presence of flame retardants/synergists has not adversely affected bonding strength.

### Press Flow Viscosity and Sag, Table 5.

Both Examples 1 and 2 show acceptable viscosity immediately after preparation, making them suitable for application by a number of methods, including a pressurized dispenser through a nozzle.

An increase in viscosity after heat-ageing indicates degradation and/or increase in molecular weight. Both Examples 1 and 2 show acceptable increases in viscosity after storage at 54° C. for 3 days in airtight containers. Comparative Example 2 shows an unacceptable increase in viscosity of more than 2-fold after heat-ageing.

When an adhesive bead is applied to a substrate, ideally it should not move appreciably and stay in the place before curing. Sag indicates how much movement occurs after application. Both Comparative Examples 1 and 2 show appreciable sag immediately after preparation, whereas inventive Examples show no sag. Comparative Example 1 shows a sag of 7 mm from the testing on its heat aged material while Comparative Example 2 was first heat aged and then tested for sag, it was extremely poor and the sag bead was totally collapsed. In contrast, Examples 1 and 2 show sags of only 2 mm after heat-ageing.

### Lap Shear Strength, Table 6.

Inventive Examples 1 and 2 show excellent lap shear strength on steel coupons. Additionally, both samples show 100% cohesive failure under both test conditions.

### Tensile Strength, Elongation at Break and Young's Modulus, Table 7.

Inventive Examples 1 and 2 show acceptable tensile strength, elongation at break and Young's modulus.

### Electrical Resistivity, Table 8.

Both Examples 1 and 2 show resistivities of greater than 10⁶Ω, making them suitable for uses in which electrical insulation is required in addition to good adhesion.

### Vertical Burn Test, Table 9.

Inventive Examples 1 and 2 showed excellent flame-retardancy, with extinguish time after first and second burns both less than 10 s. In contrast, the comparative Examples show relatively long extinguishing times after both the first and second burns.

### UL94 Burn Test Ratings, Table 10.

Inventive Examples 1 and 2 both have UL94 ratings of V0, the lowest flammability rating.

1. A one-component, moisture-curable polyurethane adhesive comprising:
(A) at least one polyurethane prepolymer;
(B) at least one amine catalyst and optionally an organometallic catalyst;
(C) the flame retardants/synergists aluminium hydroxide, melamine polyphosphate and aluminium diethylphosphinate; and
(D) optionally adhesion promoters, and fillers.

2. The adhesive of claim 1, wherein the at least one polyurethane prepolymer is made by polymerizing at least one polyether polyol and/or polyester polyol in the presence of a polyisocyanate.

3. The adhesive of claim 2, wherein the at least one polyetherpolyol is a poly(C₂-C₆-alkylene oxide)diol.

4. The adhesive of claim 2, wherein the at least one polyetherpolyol is a poly(C₂-C₄-alkylene oxide)diol.

5. The adhesive of claim 2, wherein the at least one polyetherpolyol is selected from poly(propylene oxide) diols, poly(propylene oxide) triols, and mixtures of these.

6. The adhesive of claim 1, wherein the at least one polyurethane prepolymer is a mixture of a polyether polyol-based prepolymer and a polyester polyol-based prepolymer.

7. The adhesive of claim 1, wherein the at least one polyurethane prepolymer is made by reacting a poly(propylene oxide) diol, a poly(propylene oxide) triol and a diisocyanate.

8. The adhesive of claim 1, wherein the at least one polyurethane prepolymer is a mixture of a prepolymer made by reacting a poly(propylene oxide) diol, a poly(propylene oxide) triol and a diisocyanate, and a prepolymer made by reacting an aliphatic polyester diol with a diisocyanate.

9. The adhesive of claim 7, wherein the diisocyanate is selected from IPDI, MDI, and mixtures of these.

10. The adhesive of claim 1, wherein the polyurethane prepolymer is present at 20-70 wt %, based on the total weight of the adhesive composition.

11. The adhesive of claim 1 comprising 20-70 wt % of a polyurethane prepolymer, based on the total weight of the adhesive composition, and further comprising a nominally trifunctional poly(propylene oxide) having a hydroxyl number of 36 (equivalent weight 1558) and a nominally difunctional poly(propylene oxide) having a hydroxyl number of 56 (equivalent weight 1000), reacted with MDI, and having an isocyanate content of 1.25% by weight.

12. The adhesive of claim 1, wherein the at least one polyurethane prepolymer comprises a prepolymer made by reacting an aliphatic polyester diol with a diisocyanate, at 0.5 to 5 wt %, based on the total weight of the adhesive.

13. The adhesive of claim 1, wherein the amine catalyst is selected from aliphatic cyclic and non-cyclic tertiary amines.

14. The adhesive of claim 1, wherein the amine catalyst is comprises one selected from N, N-dimethylcyclohexaneamine, triethylenediamine, N,N,N,N-tetramethylalkylenediamine, N,N,N, N-pentamethyldiethylenetriamine, triethylamine, N,N-dimethylbenzylamine, N,N-dimethylhexadecylamine, N,N-dimethylbutylamine, di(2,6-dimethylmorpholinoethyl) ether, and 2,2′-dimorpholinodiethyl ether.

15. The adhesive of claim 1, wherein the amine catalyst is 2,2′-dimorpholinodiethyl ether.

16. The adhesive of claim 1, wherein the amine catalyst is used at 0.1 to 1 wt %, based on the total weight of the adhesive composition.

17. The adhesive of claim 1, wherein the aluminium hydroxide has a median particle size of 2.6 micron.

18. The adhesive of claim 1, wherein the melamine polyphosphate has a D₅₀ of 20 microns, as measured using laser diffraction technology with a Malvern Mastersizer 2000 particle size analyzer instrument, in acetone.

19. The adhesive of claim 1, wherein the aluminium diethylphosphinate has a D₅₀ of ≤40 microns and a D₉₅ (volume %, measured using laser diffraction technology with a Malvern Mastersizer 2000 particle size analyser instrument, in acetone) of ≤10 microns.

20. The adhesive of claim 1, wherein the aluminium hydroxide is present at 15 to 30 wt %, based on the total weight of the adhesive.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
